(19) United States
(12) Patent Application Publication
(10) Pub. No.: US 2018/0127321 A1
(43) Pub. Date: May 10, 2018

(54) CERAMIC COMPOSITIONS

(71) Applicant: Imerys, Paris (FR)

(72) Inventors: Pascual GARCIA-PEREZ, A Guarda Pontevedra (ES); Jean-Paul GIRAUD, Neuvy (FR); Gilles GASGNIER, Isle (FR); Marcia Sofia GOMES-CORREIA, Caldelas (PT); Magdalena GONZALEZ-CASTRO, Tomino Pontevedra (ES); Jean-André ALARY, L'lsle sur la Sorgue (FR)

(21) Appl. No.: 15/574,223

(22) PCT Filed: May 12, 2016
(86) PCT No.: PCT/EP2016/060722

§ 371 Date: Nov. 15, 2017

(30) Foreign Application Priority Data
May 15, 2015 (EP) 15305733.6

(51) Int. Cl. C04B 38/00; B01J 21/06; B01J 35/04; B01J 37/08; B01J 37/02; B01D 53/94; B01D 46/24; F01N 3/20; F01N 3/022

(52) U.S. Cl. CPC C04B 38/0006; B01J 21/063; B01J 35/04; B01J 37/08; B01J 37/0215; B01D 2255/9205; B01D 46/2418; F01N 3/2066; F01N 3/022; B01D 2046/2433; B01D 53/9418

(57) ABSTRACT

A ceramic precursor composition suitable for sintering form a ceramic material or structure therefrom, for example, a ceramic honeycomb structure, a ceramic material or structure, for example, a ceramic honeycomb structure obtainable by sintering said ceramic precursor composition, a method for preparing said ceramic precursor composition and ceramic material or structure, for example, ceramic honeycomb structure, a diesel particulate filter comprising said ceramic structure, a selective diesel particulate filter comprising said ceramic structure, a gasoline particulate filter comprising said ceramic structure, a vehicle comprising said diesel particulate filter, selective diesel particulate filter or gasoline particulate filter, and a SCR catalyst system comprising said ceramic material or structure.

### TECHNICAL FIELD

The present application is directed to a ceramic precursor composition suitable for sintering form a ceramic material or structure therefrom, for example, a ceramic honeycomb structure, to a ceramic material or structure, for example, a ceramic honeycomb structure obtainable by sintering said ceramic precursor composition, to a method for preparing said ceramic precursor composition and ceramic material or structure, for example, ceramic honeycomb structure, to a diesel particulate filter comprising said ceramic structure, to a selective diesel particulate filter comprising said ceramic structure, to a gasoline particulate filter comprising said ceramic structure, to a vehicle comprising said diesel particulate filter, selective diesel particulate filter or gasoline particulate filter, and to a SCR catalyst system comprising said ceramic material or structure.

### BACKGROUND

Ceramic structures, particularly ceramic honeycomb structures, are known in the art for the manufacture of filters for liquid and gaseous media. The most relevant application today is in the use of such ceramic structures as particle filters for the removal of fine particles from the exhaust gas of diesel engines of vehicles (diesel particulates), since those fine particulates have been shown to have negative influence on human health.

A summary on the ceramic materials known for this application is given in the paper of J. Adler, Int. J. Appl. Ceram. Technol. 2005, 2(6), p429-439, the content of which is incorporated herein in its entirety for all purposes.

Several ceramic materials have been described for the manufacture of ceramic honeycomb filters suitable for that specific application.

For example, honeycombs made from ceramic materials based on mullite and tialite have been used for the construction of diesel particulate filters. Mullite is an aluminium and silicon containing silicate mineral of variable composition between the two defined phases [3Al₂O₃.2SiO₂] (the so-called “stoichiometric” mullite or “3:2 mullite”) and [2Al₂O₃.1SiO₂] (the so-called “2:1 mullite”). The material is known to have a high melting point, refractoriness and fair mechanical properties. Tialite is an aluminium titanate having the formula [Al₂Ti₂O₅]. The material is known to show a high thermal shock resistance, low thermal expansion and a high melting point.

Owing to these properties, tialite has traditionally been a favoured material of choice for the manufacture of honeycomb structures. For example, US-A-20070063398 describes porous bodies for use as particulate filters comprising over 90% tialite. Similarly, US-A-20100230870 describes ceramic bodies suitable for use as particulate filters having an aluminium titanate content of over 90 mass %.

Attempts have also been made to combine the positive properties of mullite and tialite, e.g., by developing ceramic materials comprising both phases.

WO-A-2009/076985 describes a ceramic honeycomb structure comprising a mineral phase of mullite and a mineral phase of tialite. The examples describe a variety of ceramic structures typically comprising at least about 65 vol. % mullite and less than 15 vol. % tialite.

WO-A-2014/053281 describes a ceramic material providing desirable mechanical strength in combination with excellent thermal shock resistance which comprises a relatively low amount of a tialite phase in combination with an amount of mullite.

As noted from the above mentioned references, considerable focus has been placed on the relative amounts of tialite and mullite in the ceramic structures and how this affects properties such as strength, thermal shock resistance and thermal expansion.

It is also known to coat porous ceramic structures with SCR (Selective Catalyst Reduction) catalysts. An example of such a structure is described in US-A-2013136662 utilizing ammonia as reducing agent in the conversion of NOₓ gases to N₂ and water.

The filtering efficiency of these ceramic structures may depend upon the physical and thermal mechanical properties (e.g., wall thickness, density, porosity, pore size, etc) of the filter. High porosity is desirable, but there it is an ongoing challenge to prepare ceramic structures having both high porosity and high thermal mechanical properties.

### SUMMARY OF THE INVENTION

According to a first aspect, there is provided a ceramic precursor composition having at least a trimodal particle size distribution, the ceramic precursor composition comprising:
(a) a first inorganic particulate material having a coarse particle size distribution;
(b) a second inorganic particulate material having a particle size distribution which is finer than (a);
(c) a third inorganic particulate material having a d₅₀ of equal to or less than about 5 μm and optionally having a particle size distribution which is finer than (b); and
(d) a or at least one pore forming agent, for example, in an amount suitable to obtain a ceramic material having a porosity of at least about 50% (calculated on the basis of the total volume of the mineral phases and pore space of the ceramic material).

According to a second aspect, there is provided a method for making a ceramic material or structure having a tialite content of at least about 50% by weight and a porosity of at least about 50%, said method comprising:
(i) providing, preparing or obtaining a ceramic precursor having at least a trimodal particle size and having a compositing comprising:
   (a) a first inorganic particulate material having a coarse particle size distribution;
   (b) a second inorganic particulate material having a particle size distribution which is finer than (a);
   (c) a third inorganic particulate material having a d₅₀ of equal to or less than about 5 μm and optionally having a particle size distribution which is finer than (b); and
   (d) a or at least one pore forming agent in an amount suitable to obtain a ceramic material having a porosity of at least about 50%;
(ii) forming a green ceramic material from the ceramic precursor composition, and
(iii) sintering the green ceramic material.

According to a third aspect, there is provided a ceramic material or structure having a tialite content of at least about 50 wt. %, based on the total weight of the ceramic material or structure, and a porosity of at least about 50%, wherein the ceramic material or structure is obtained or prepared by a method comprising:
(i) providing, preparing or obtaining a ceramic precursor having at least a trimodal particle size and having a composition comprising:
   (a) a first inorganic particulate material having a coarse particle size distribution;
   (b) a second inorganic particulate material having a particle size distribution which is finer than (a);
   (c) a third inorganic particulate material having a d₅₀ of equal to or less than about 5 μm and optionally having a particle size distribution which is finer than (b); and
   (d) a or at least one pore forming agent in an amount suitable to obtain a ceramic material or structure having a porosity of at least about 50%;
(ii) forming a green ceramic material or structure from the ceramic precursor composition, and
(iii) sintering the green ceramic material or structure, for example, at a temperature higher than 1400° C.

According to a fourth aspect, there is provided a ceramic structure according to the third aspect in the form of a ceramic honeycomb structure.

According to a fifth aspect, there is provided a diesel particulate filter comprising or made from the ceramic honeycomb structure according to the fourth aspect, or obtainable by certain embodiments of the method according to the second aspect.

According to a sixth aspect, there is provided a selective diesel particulate filter comprising or made from the ceramic honeycomb structure according to the fourth aspect, or obtainable by certain embodiments of the method according to the second aspect.

According to a seventh aspect, there is provided a gasoline particulate filter comprising or made from the ceramic honeycomb structure according to the fourth aspect, or obtainable by certain embodiments of the method according to the second aspect.

According to an eighth aspect, there is provided a vehicle having a diesel engine and a filtration system comprising: (i) the diesel particulate filter according to the fifth aspect or (ii) the selective diesel particulate filter according to the sixth aspect.

According to a ninth aspect, there is provided a vehicle having a gasoline engine and a filtration system comprising the gasoline particulate filter according to the seventh aspect.

According to a tenth aspect, there is provided a SCR catalyst system comprising a ceramic material or structure according to third or fourth aspects and an SCR catalyst, optionally coated on a surface of the ceramic material or structure.

### DETAILED DESCRIPTION OF THE INVENTION

It has surprisingly been found that ceramic structures possessing both high porosity and high thermal mechanical properties may be prepared from, e.g., by sintering, a ceramic precursor composition having at least a trimodal particle size distribution in combination with a pore forming agent. Without wishing to be bound by theory, it is believed the trimodal particle size distribution enhances closer packing of the particulate materials, providing a denser ceramic having sufficient wall strength to support a highly porous structure.

The porosity of the ceramic materials and structures, e.g., ceramic honeycomb, is calculated on the basis of the total volume of the mineral phases and pore space. The “total volume of the mineral phases” of a ceramic material or structure refers to the total volume of the material or structure without the pore volume, i.e., only solid phases are considered. The “total volume of the mineral phases and pore space” refers to the apparent volume of the ceramic material or structure, i.e., including solid phases and pore volume. Porosity may be determined in accordance with any suitable method. In certain embodiments, porosity is determined by mercury diffusion as measured using a Thermo Scientific Mercury Porosimiter—Pascal 140, with a contact angle of 130 degrees, or any other measurement method which gives an equivalent result.

The amounts of tialite, mullite and other mineral phases in the ceramic material or structure, e.g., ceramic honeycomb structure, may be measured using qualitative X-ray diffraction (Cu Kα radiation, 40 KV, 30 mA, Rietveld analysis with a 15 wt. % Si standard), or any other measurement method which gives an equivalent result. As will be understood by the skilled person, in the X-ray diffraction method, the sample is milled. After milling, the powder is homogenized, and then filled into the sample holder of the X-ray diffractometer. The powder is pressed into the holder and any overlapping powder is removed to ensure an even surface. After placing the sample holder containing the sample into the X-ray diffractometer, the measurement is started. Typical measurement conditions are a step width of 0.030°, a measurement time of 7 seconds per step and a measurement range from 10 to 60° 2θ. The resulting diffraction pattern is used for the quantification of the different phases, which the sample material consists of, by using appropriate software capable of Rietveld refinement. A suitable diffractometer is a SIEMENS D5000, and suitable Rietveld software is BRUKER AXS DIFFRAC^{plus} TOPAS. The amount of each mineral phase in the ceramic material or structure, e.g., ceramic honeycomb structure, is expressed as a weight % based on the total weight of the mineral phases.

Unless otherwise stated, the particle size properties referred to herein, for example, for the inorganic particulate material, e.g., mineral, starting materials or pore forming agent are as measured by the well known conventional method employed in the art of laser light scattering, using a Malvern Mastersizer 2000 machine as supplied by Malvern Instruments Ltd (or by other methods which give essentially the same result). In the laser light scattering technique, the size of particles in powders, suspensions and emulsions may be measured using the diffraction of a laser beam, based on an application of Mie theory. Such a machine provides measurements and a plot of the cumulative percentage by volume of particles having a size, referred to in the art as the ‘equivalent spherical diameter’ (e.s.d), less than given e.s.d values. The mean particle size d₅₀ is the value determined in this way of the particle e.s.d at which there are 50% by volume of the particles which have an equivalent spherical diameter less than that d₅₀ value. The d₁₀ and d₉₀ are to be understood in similar fashion.

Unless otherwise stated, in each case, the lower and upper limits of a range are d₅₀ values.

In the case of colloidal titania, the particle size is measured using transmission electron microscopy.

Unless otherwise stated, the measurement of the particle sizes of components which are present in the ceramic material or structure, e.g., honeycomb structure, in a particulate form may be accomplished by image analysis.

The ceramic precursor composition, which is suitable for sintering to form a ceramic structure therefrom, has at least a trimodal particle size distribution, and comprises:
(a) a first inorganic particulate material having a coarse particle size distribution;
(b) a second inorganic particulate material having a particle size distribution which is finer than (a);
(c) a third inorganic particulate material having a d₅₀ of equal to or less than about 5 μm and optionally having a particle size distribution which is finer than (b); and
(d) a or at least one pore forming agent

By “trimodal” is meant that the ceramic precursor composition comprises at least three inorganic particulate material components which each have a unique particle size distribution (e.g., d₅₀) with respect to the other inorganic particulate materials in the ceramic precursor composition. In certain embodiments, the ceramic precursor composition has a trimodal particle size distribution. In certain embodiments, the ceramic precursor composition has a tetramodal particle size distribution, or a pentamodal particle size distribution, or a hexamodal particle size distribution.

The first inorganic particulate material has a relatively coarse particle size distribution, i.e., relative to the at least two other inorganic particulate materials in the ceramic precursor composition.

The second inorganic particulate material has a particle size distribution which is finer than the first inorganic particulate material, e.g., a d₅₀ which is lower than the d₅₀ of the first inorganic particulate material.

The third inorganic particulate material has a d₅₀ of equal to or less than about 5 μm. In certain embodiments, the third inorganic particulate material is finer than the second inorganic particulate material, i.e., has a d₅₀ which is lower than the d₅₀ of the second inorganic particulate material.

In certain embodiments, the first inorganic particulate material has a d₅₀ of from about 20 μm to about 80 μm, for example, from about 20 μm to about 60 μm, or from about 20 μm to about 40 μm; and/or the second inorganic particulate material has a d₅₀ of from about 1.0 μm to about 20 μm, or from about 1.0 μm to less than about 20 μm, or from about 1.0 μm to about 15 μm, or from about 1.0 μm to about 10 μm; and/or the third inorganic particulate material has a d₅₀ of equal to or less than about 5 μm and/or a particle size distribution finer than the second inorganic particulate material.

In certain embodiments, the first inorganic particulate material has a d₅₀ of from about 20 μm to about 80 μm, the second inorganic particulate material has a d₅₀ of from about 1.0 μm to about 20 μm, or from about 1.0 μm to less than 20 μm, and the third inorganic particulate material has a d₅₀ of equal to or less than about 5 μm and/or a particle size distribution finer than the second inorganic particulate material.

In certain embodiments, the first inorganic particulate material has a d₅₀ of from about 20 μm to about 40 μm, the second inorganic particulate material has a d₅₀ of from about 1.0 μm to about 10 μm, and the third inorganic particulate material has a d₅₀ of equal to or less than about 5 μm and/or a particle size distribution finer than the second inorganic particulate material.

In certain embodiments, the first inorganic particulate material has a d₅₀ of from about 20 μm to about 35 μm, for example, from about 20 μm to about 30 μm, or from about 20 μm to about 25 μm, or from about 25 μm to about 35 μm, or from about 30 μm to about 40 μm, or from about 30 μm to about 35 μm. In such embodiments, the first inorganic particulate may have a d₉₀ of from about 30 μm to about 60 μm, for example, from about 35 μm to about 55 μm, or from about 30 μm to 40 μm, or from about 45 μm to about 55 μm, or from about 55 μm to about 75 μm. By definition, the d₉₀ is always larger than the d₅₀. Additional or alternatively, the first inorganic particulate may have a d₁₀ of from about 10 μm to about 25 μm, for example, from about 15 μm to about 25 μm, or from about 10 μm to about 20 μm, or from about 15 μm to about 25 μm. By definition, the d₁₀ is always smaller than the d₅₀.

In certain embodiments, the first inorganic particulate material has a d₅₀ of from about 20 μm to about 30 μm, a d₉₀ of from about 30 μm to about 40 μm, and a d₁₀ of from about 10 μm to about 20 μm.

In certain embodiments, the first inorganic particulate material has a d₅₀ of from about 30 μm to about 40 μm, a d₉₀ of from about 40 μm to about 60 μm, and a d₁₀ of from about 15 μm to about 25 μm.

In certain embodiments, the second inorganic particulate material has a d₅₀ of from about 2 μm to about 20 μm, for example, from about 2 μm to less than about 20 μm, or from about 2 μm to about 14 μm, or from about 2 to about 8 μm, or from about 3 μm to about 6 μm, or from about 5 μm to about 9 μm, or from about 3.5 μm to about 5 μm, or from about 6.5 μm to about 8 μm. In such embodiments, the second inorganic particulate may have a d₉₀ of from about 5 μm to about 15 μm, for example, from about 5 μm to about 10 μm, or from about 10 μm to about 15 μm. Additionally or alternatively, the second inorganic particulate material may have a d₁₀ of from about 0.5 μm to about 5 μm, for example, from about 1 μm to about 3 μm, or from about 3 μm to about 5 μm.

In certain embodiments, the second inorganic particulate material has a d₅₀ of from about 6.5 to about 8 μm, a d₉₀ of from about 10 μm to about 15 μm, and a d₁₀ of from about 3 μm to about 5 μm.

In certain embodiments, the second inorganic particulate material has a d₅₀ of from about 3 to about 6 μm, a d₉₀ of from about 5 μm to about 10 μm, and a d₁₀ of from about 1 μm to about 3 μm.

In certain embodiments, the third inorganic particulate has a d₅₀ of equal to or less than about 5 μm, for example, equal to or less than about 4.5 μm, for example, equal to or less than about 4 μm, or equal to or less than about 3.5 μm, or equal to or less than about 3 μm, or equal to or less than about 2.5 μm, or equal to or less than about 2 μm, or equal to or less than about 1.5 μm, or equal to or less than about 1 μm, or equal to or less than about 0.5 μm, or equal to or less than about 0.25 μm. In certain embodiments, the third inorganic particulate has a d₅₀ of at least about 0.05 μm, for example, at least about 0.075 μm, or at least about 0.1 μm. In such embodiments, the third inorganic particulate material may have a d₉₀ of from about 0.25 μm to about 10 μm, for example, from about 0.5 μm to about 7.5 μm, or from about 0.5 μm to about 5 μm, or from about 0.5 μm to about 2.5 μm, or from about 0.5 μm to about 2 μm, or from about 0.5 μm to about 1.5 μm, or from about 0.5 μm to about 1 μm. Additionally or alternatively, the third inorganic particulate may have a d₁₀ of from about 0.025 μm to about 5 μm, for example, from about 0.025 to about 2.5 μm, or from about 0.04 to about 1.5 μm, or from about 0.025 to about 1.0 μm, or from about 0.025 to about 0.5 μm, or from about 0.025 to about 0.25 μm, or from about 0.025 to about 0.15 μm, or from about 0.025 to about 0.1 μm, or from about 0.025 to about 0.075 μm.

In certain embodiments, the third inorganic particulate has a d₅₀ of equal to or less than about 5 μm, a d₉₀ of from about 0.5 μm to about 2.5 μm and a d₁₀ of from about 0.025 μm to about 0.15 μm.

In certain embodiments, the third inorganic particulate material has a d₅₀ of equal to or less than about 2 μm, a d₉₀ of from about 0.5 μm to about 2.5 μm and a d₁₀ of from about 0.025 μm to about 0.15 μm.

In certain embodiments, the third inorganic particulate material has a d₅₀ of equal to or less than about 0.5 μm, a d₉₀ of from about 0.5 μm to about 1.5 μm and a d₁₀ of from about 0.025 μm to about 0.1 μm.

In certain embodiments, the third inorganic particulate material has a d₅₀ of from about 0.5 μm to about 1.5 μm, for example, from about 0.5 μm to about 1 μm.

In certain embodiments, the third inorganic particulate material has a d₅₀ of from about 1 μm to about 3 μm, for example, from about 1.5 μm to about 2.5 μm.

In certain embodiments, the third inorganic particulate material has a d50 of from about 0.75 μm to about 2.25 μm, for example, from about 1 μm to about 2 μm.

The inorganic particulate materials, e.g., solid mineral compounds, suitable for use as raw materials in the ceramic precursor compositions (aluminosilicate, alumina, titania, tialite, mullite, chamotte, etc.) can be used in the form of powders, suspensions, dispersions, and the like. Corresponding formulations are commercially available and known to the skilled person in the art. For example, powdered andalusite is commercially available under the trade name Kerphalite (Damrec), powdered alumina and alumina dispersions are available from Evonik Gmbh or Nabaltec, and powdered titania and titania dispersions are available from Cristal Global.

In certain embodiments, the first inorganic particulate material comprises or is selected from tialite, one or more tialite-forming precursor compounds or compositions, mullite and one or more mullite forming precursor compounds or compositions; and/or the second inorganic particulate material comprises or is selected from tialite, one or more tialite-forming precursor compounds or compositions, mullite and one or more mullite forming precursor compounds or compositions; and/or the third inorganic particulate is a tialite-forming precursor compound or composition.

In certain embodiments, the first inorganic particulate material comprises or is selected from tialite, one or more tialite-forming precursor compounds or compositions, mullite and one or more mullite forming precursor compounds or compositions; the second inorganic particulate material comprises or is selected from tialite, one or more tialite-forming precursor compounds or compositions, mullite and one or more mullite forming precursor compounds or compositions; and the third inorganic particulate is a tialite-forming precursor compound or composition.

In certain embodiments, the first inorganic particulate comprises tialite and up to about 10 wt. % of a Zr-containing mineral phase and/or one or more Zr-containing mineral phase-forming compounds or compositions, based on the total weight of the first inorganic particulate material, for example, up to about 8 wt. %, or up to about 7 wt. %, or up to about 6 wt. %, or up to about 5 wt. %, or up to about 4 wt. %, or up to about 3 wt. %, or up to about 2 wt. %, or up to about 1 wt. %, or up to about 0.5 wt. %, or up to about 0.25 wt. % of a Zr-containing mineral phase and/or one or more Zr-containing mineral phase-forming compounds or compositions. Additionally or alternatively, the first inorganic particulate material may comprise up to about 5 wt. % of an alkaline earth metal-containing mineral phase and/or or one or more alkaline earth metal-containing mineral phase-forming compounds or compositions, based on the total weight of the first inorganic particulate material, for example, up to about 4 wt. %, or up to about 3 wt. %, or up to about 2 wt. %, or up to about 1 wt. %, or up to about 0.5 wt. % of an alkaline earth metal-containing mineral phase and/or or one or more alkaline earth metal-containing mineral phase-forming compounds or compositions. In such embodiments, the first inorganic particulate may comprise at least about 80 wt. % tialite, based on the total weight of the first inorganic particulate material, for example, from about 80 wt. % to about 100 wt. %, or from about 80 wt. % to about 99 wt. %, or from about 85 wt. % to about 95 wt. %, or from about 90 wt. % to about 95 wt. %, or at least about 91 wt. %, or at least about 92 wt. %.

In certain embodiments, the first inorganic particulate material is substantially free of a Zr-containing mineral phase and/or one or more Zr-containing mineral phase-forming compounds or compositions, and/or the first inorganic particulate material is substantially free of an alkaline earth metal-containing mineral phase and/or or one or more alkaline earth metal-containing mineral phase-forming compounds or compositions.

As used herein, the term “substantially free” refers to the total absence of or near total absence of a specific compound or composition or mineral phase. For example, when the ceramic composition is said to be substantially free of a Zr-containing mineral phase and/or one or more Zr-containing mineral phase-forming compounds or compositions, there is either no such mineral phase and mineral phase-forming compounds or compositions in the first inorganic particulate material or only trace amounts. A person skilled in the art will understand that a trace amount is an amount which may be detectable by the XRD method described above, but not quantifiable and moreover, if present, would not adversely affect the properties of the ceramic precursor composition.

In certain embodiments, the first inorganic particulate comprises mullite and up to about 5 wt. % of a Zr-containing mineral phase and/or one or more Zr-containing mineral phase-forming compounds or compositions, based on the total weight of the first inorganic particulate material, for example, up to about 4 wt. %, or up to about 3 wt. %, or up to about 2 wt. %, or up to about 1 wt. %, or up to about 0.5 wt. %, or up to about 0.25 wt. % of a Zr-containing mineral phase and/or one or more Zr-containing mineral phase-forming compounds or compositions.

Additionally or alternatively, the first inorganic particulate material may comprise up to about 2.5 wt. % of an alkaline earth metal-containing mineral phase and/or or one or more alkaline earth metal-containing mineral phase-forming compounds or compositions, based on the total weight of the first inorganic particulate material, for example, up to about 2 wt. %, or up to about 1.5 wt. %, or up to about 1 wt. %, or up to about 0.5 wt. %, or up to about 0.25 wt. % of an alkaline earth metal-containing mineral phase and/or or one or more alkaline earth metal-containing mineral phase-forming compounds or compositions. In such embodiments, the first inorganic particulate material is substantially free of a Zr-containing mineral phase and/or one or more Zr-containing mineral phase-forming compounds or compositions, and/or the first inorganic particulate material is substantially free of an alkaline earth metal-containing mineral phase and/or or one or more alkaline earth metal-containing mineral phase-forming compounds or compositions. In such embodiments, the first inorganic particulate may comprise at least about 90 wt. % mullite, based on the total weight of the first inorganic particulate material, for example, from about 95 wt. % to about 100 wt. %, or from about 95 wt. % to about 99 wt. %, or from about 95 wt. % to about 98 wt. %, or from about 95 wt. % to about 97 wt. %, or at least about 95 wt. % mullite, or at least about 96 wt. % mullite.

In certain embodiments, the first inorganic particulate material is selected from tialite, one or more tialite-forming precursor compounds or compositions, mullite and one or more mullite forming precursor compounds or compositions. In certain embodiments, the first inorganic particulate is tialite, mullite or a mixture of tialite and mullite. In certain embodiments, the first inorganic material is selected from selected from mullite, tialite, aluminosilicate, titania and alumina. In certain embodiments, the first inorganic particulate material is tialite. In certain embodiments, the first inorganic particulate material is a mixture of tialite and mullite, for example, in a weight ratio of tialite to mullite of from about 1:5 to about 1:10. In certain embodiments, the first inorganic particulate material is a mullite forming precursor composition, for example, comprising at least about 50% by weight alumina and less than about 50% by weight silica, for example, at least about 75% by weight alumina and less than about 25% by weight silica. In such embodiments, the mullite forming precursor composition may have a d₅₀ of from about 40 μm to about 80 μm, for example, form about 50 μm to about 70 μm, or from about 55 μm to about 65 μm.

In certain embodiments, the second inorganic particulate material is selected from tialite, one or more tialite-forming precursor compounds or compositions, mullite and one or more mullite forming precursor compounds or compositions. In certain embodiments, the second inorganic particulate is mullite, tialite or a mixture of mullite and tialite. In certain embodiments, the second inorganic material is selected from mullite, tialite, aluminosilicate, titania and alumina. In certain embodiments, the second inorganic material is mullite. In certain embodiments, the second inorganic particulate material is tialite. In certain embodiments, the second inorganic particulate material is a mixture of tialite and mullite, for example, in a weight ratio of tialite to mullite of from about 5:1 to about 1:5, for example, from about 4:1 to about 1:4, or from about 3:1 to about 1:3, or from about 2:1 to about 1:2.

In certain embodiments, the second inorganic particulate material comprises at least about 90 wt. % mullite, for example, at least about 95 wt. % mullite, or at least about 99 wt. % mullite, or essentially 100 wt. % mullite.

In certain embodiments, for example, embodiments in which the first inorganic particulate material is a mullite forming precursor composition, the second inorganic particulate material is tialite precursor composition comprising at least about 90% by weight titania and up to about 5% by weight an alkaline earth metal-containing mineral phase such as, for example, magnesium oxide. In certain embodiments, the second inorganic particulate is a tialite precursor composition at least about 95% by weight titania, or up to about 99% by weight titania, and up to about 5% magnesium oxide, for example, up to about 1% by weight magnesium oxide.

In certain embodiments, the second inorganic particulate material has the same chemical composition as the first inorganic particulate, thereby differing only in particle size distribution.

In certain embodiments, the first inorganic particulate material is tialite and the second inorganic particulate material is mullite. In certain embodiments the first inorganic particulate material is tialite, and the second inorganic particulate material is a mixture of tialite and mullite, as described above. In certain embodiments, the first inorganic particulate material is a mixture of tialite and mullite, as described above, and the second inorganic particulate is mullite or a mixture of tialite and mullite, as described above. In certain embodiments, the first inorganic particulate is mullite, and the second inorganic particulate material is tialite.

In certain embodiments, the third inorganic particulate material is a composition comprising titania, alumina, optionally an alkaline earth metal-containing mineral phase and/or one or more alkaline earth metal-containing mineral phase-forming compounds or compositions and optionally a Zr-containing mineral phase and/or one or more Zr-containing mineral phase-forming compounds or compositions. In certain embodiments, the third inorganic particulate material is substantially free of a Zr-containing mineral phase and/or one or more Zr-containing mineral phase-forming compounds or compositions.

In certain embodiments, the third inorganic particulate material comprises at least about 90 wt. % of alumina and/or titania, based on the total weight of the third inorganic particulate material, for example, at least about 92 wt. % of alumina and/or titania, or at least about 94 wt. % of alumina and/or titania, or at least about 95 wt. % of alumina and/or titania, or at least about 96 wt. % of alumina and/or titania, or at least about 97 wt. % of alumina and/or titania, or at least about 98 wt. % of alumina and/or titania, or at least about 99 wt. % of alumina and/or titania. In certain embodiments, the third inorganic particulate material comprises up to about 5 wt. % of an alkaline earth metal-containing mineral phase and/or or one or more alkaline earth metal-containing mineral phase-forming compounds or compositions, based on the total weight of the third inorganic particulate material, for example, up to about 4 wt. %, or up to about 3 wt. %, or up to about 2 wt. %, or up to about 1 wt. % of an alkaline earth metal-containing mineral phase and/or or one or more alkaline earth metal-containing mineral phase-forming compounds or compositions. In certain embodiments, the third inorganic particulate material is substantially free of an alkaline earth metal-containing mineral phase and/or or one or more alkaline earth metal-containing mineral phase-forming compounds or compositions.

Aluminosilicate may be selected from one or more of andalusite, kyanite, sillimanite, mullite, molochite, a hydrous kandite clay such as kaolin, halloysite or ball clay, or an anhydrous (calcined) kandite clay such as metakaolin or fully calcined kaolin.

Titania may be selected from one or more of rutile, anatase, brookite.

Aluminium titanate may be selected from alumina and titania precursors, sintered aluminium titanate or fused aluminium titanate.

The Zr-containing mineral phase and/or one or more Zr-containing mineral phase-forming compounds or compositions may be selected from one or more of ZrO₂ and zirconium titanate, e.g., TiₓZr₁₋ₓO₂, wherein x is from 0.1 to 0.9, for example, greater than about 0.5. In certain embodiments, the Zr-containing mineral phase and/or one or more Zr-containing mineral phase-forming compounds or compositions is a mixture of ZrO₂ and zirconium titanate.

The alkaline earth metal-containing mineral phase and/or one or more alkaline earth metal-containing mineral phase-forming compounds or compositions may be selected from one or more of M-oxide, M-carbonate or M-titanate, where M is Mg, Ca or Ba, preferably Mg.

Alumina may be selected from one or more of fused alumina (e.g., corundum), sintered alumina, calcined alumina, reactive or semi-reactive alumina, and bauxite.

In all of the above embodiments comprising the use of alumina (Al₂O₃), titania (TiO₂) and zirconia (ZrO₂), the alumina, titania and/or zirconia may be partially or fully replaced by alumina, titania and/or zirconia precursor compounds. By the term “alumina precursor compounds”, such compounds are understood which may comprise one or more additional components to aluminum (Al) and oxygen (O), which additional components are removed during subjecting the alumina precursor compound to sintering conditions, and wherein the additional components are volatile under sintering conditions. Thus, although the alumina precursor compound may have a total formula different from Al₂O₃, only a component with a formula Al₂O₃ (or its reaction product with further solid phases) is left behind after sintering. Thus, the amount of alumina precursor compound present in the ceramic precursor composition, or an extrudable mixture prepared therefrom, or a green honeycomb structure, can be easily recalculated to represent a specific equivalent of alumina (Al₂O₃). The terms “titania precursor compound” and “zirconia precursor compound” are to be understood in similar fashion.

Examples for alumina precursor compounds include, but are not limited to aluminum salts such as aluminum phosphates, and aluminum sulphates, or aluminum hydroxides such as boehmite (AlO(OH) and gibbsite (Al(OH)₃). The additional hydrogen and oxygen components present in those compounds are set free during sintering in the form of water. Usually, alumina precursor compounds are more reactive in solid phase reactions occurring under sintering conditions, than alumina (Al₂O₃) itself.

When used, the aluminosilicate and in (part) alumina may be considered as the main mullite-forming components of the ceramic precursor composition. During primary mullitization, aluminosilicate decomposes and mullite forms. In secondary mullitization, excess silica from the aluminosilicate reacts with any remaining alumina, forming further mullite. As described below, the ceramic precursor composition may be sintered to a suitably high temperature such that substantially all aluminosilicate and alumina has been consumed in the primary and secondary mullitization stages.

In certain embodiments, the third inorganic particulate material is a composition comprising from about 40 wt. % to about 60 wt. % titania, from about 40 wt. % to about 60 wt. % alumina, from about 0 wt. % up to about 5 wt. % of an alkaline earth metal-containing mineral phase and/or or one or more alkaline earth metal-containing mineral phase-forming compounds or compositions, and from about 0 wt. % to about 5 wt. % of a Zr-containing mineral phase and/or one or more Zr-containing mineral phase-forming compounds or compositions, based on the total weight of the third inorganic particulate material.

The relative amounts of the first, second and third inorganic particulate materials may be selected such that upon sintering the ceramic precursor composition at a temperature higher than about 1400° C., or higher than about 1500° C., a ceramic material or structure, for example, a ceramic honeycomb structure, according to the third aspect of the present invention, or obtainable by the method according the second aspects of the present invention, is obtained.

In certain embodiments, the ceramic precursor composition comprises from about 20 wt. % to about 60 wt. % of the first inorganic particulate material, from about 15 wt. % to about 50 wt. % of the second inorganic particulate material, and from about 15 wt. % to about 50 wt. % of the third inorganic particulate material, based on the total combined weight of the first, second and third inorganic particulate materials. If the ceramic precursor composition had a tetramodal particle size distribution, then the amounts described herein would be based on the total combined weight of the first, second, third and fourth inorganic particulate materials.

In certain embodiments, the ceramic precursor composition comprises from about 25 wt. % to about 55 wt. % of the first inorganic particulate material, for example, from about 25 wt. % to about 55 wt. %, or from about 25 wt. % to about 50 wt. %, or from about 30 wt. % to about 45 wt. %, or from about 35 wt. % to about 45 wt. %, or from about 30 wt. % to about 40 wt. %, or from about 30 wt. % to about 35 wt. %, or from about 35 wt. % to about 40 wt. %, based on the total combined weight of the first, second and third inorganic particulate materials.

In certain embodiments, the ceramic precursor composition comprises from about 20 wt. % to about 45 wt. % of the second inorganic particulate material, for example, from about 20 wt. % to about 40 wt. %, or from about 20 wt. % to about 35 wt. %, or from about 25 wt. % to about 40 wt. %, or from about 25 wt. % to about 35 wt. %, or from about 30 wt. % to about 40 wt. %, or from about 30 wt. % to about 35 wt. %, based on the total combined weight of the first, second and third inorganic particulate materials.

In certain embodiments, the ceramic precursor composition comprises from about 20 wt. % to about 45 wt. % of the third inorganic particulate material, for example, from about 20 wt. % to about 40 wt. %, or from about 20 wt. % to about 35 wt. %, or from about 25 wt. % to about 40 wt. %, or from about 25 wt. % to about 35 wt. %, or from about 30 wt. % to about 40 wt. %, or from about 30 wt. % to about 35 wt. %, or from about 25 wt. % to about 30 wt. %, based on the total combined weight of the first, second and third inorganic particulate materials.

In certain embodiments, the ceramic precursor composition comprises from about 25 wt. % to about 40 wt. % of the first inorganic particulate material, from about 25 wt. % to about 40 wt. % of the second inorganic particulate material, and from about 25 wt. % to about 35 wt. % of the third inorganic particulate material, based on the total combined weight of the first, second and third inorganic particulate materials.

In certain embodiments, the ceramic precursor composition comprises from about 30 wt. % to about 40 wt. % of the first inorganic particulate material, from about 30 wt. % to about 40 wt. % of the second inorganic particulate material, and from about 25 wt. % to about 35 wt. % of the third inorganic particulate material, based on the total combined weight of the first, second and third inorganic particulate materials.

In certain embodiments, the ceramic precursor composition comprises from about 40 wt. % to about 60 wt. % of the first inorganic particulate material, from about 15 wt. % to about 35 wt. % of the second inorganic particulate material, and from about 15 wt. % to about 35 wt. % of the third inorganic particulate material, based on the total combined weight of the first, second and third inorganic particulate materials.

In certain embodiments, the ceramic precursor composition comprises from about 45 wt. % to about 55 wt. % of the first inorganic particulate material, from about 15 wt. % to about 35 wt. % of the second inorganic particulate material, and from about 15 wt. % to about 30 wt. % of the third inorganic particulate material, based on the total combined weight of the first, second and third inorganic particulate materials.

In certain embodiments, the ceramic precursor composition comprises from about 45 wt. % to about 55 wt. % of the first inorganic particulate material, from about 15 wt. % to about 25 wt. % of the second inorganic particulate material, and from about 25 wt. % to about 30 wt. % of the third inorganic particulate material, based on the total combined weight of the first, second and third inorganic particulate materials.

In certain embodiments, the ceramic precursor composition comprises from about 45 wt. % to about 55 wt. % of the first inorganic particulate material, from about 15 wt. % to about 25 wt. % of the second inorganic particulate material, and from about 15 wt. % to about 25 wt. % of the third inorganic particulate material, based on the total combined weight of the first, second and third inorganic particulate materials.

In certain embodiments, the weight ratio of the first inorganic particulate material to the third inorganic particulate material is no greater than about 3:1, for example, no greater than about 2.5:1, or no greater than about 2:1. Additionally or alternatively, in certain embodiments, the weight ratio the first inorganic particulate material to the second inorganic particulate material is no greater than about 3:1, for example, no greater than about 2.5:1, or no greater than about 2:1, or no greater than about 1.5:1. Additionally or alternatively, in certain embodiments, the weight ratio of the second inorganic particulate material to the third inorganic particulate material is from about 0.5:1 to about 2:1, for example, from about 0.75:1 to about 1.5:1.

As described above, the ceramic precursor composition further comprises a pore forming agent. A pore forming agent is a species which induces and enhances the generation of porosity in the ceramic material structure obtained from the ceramic precursor composition. The pore forming agent may be a mixture of pore forming agents.

In certain embodiments, the pore forming agent is present in an amount suitable to obtain (e.g., by firing or sintering the ceramic precursor composition) a ceramic material or structure having a porosity of at least about 50%, for example, at least about 55%, or at least about 60%, or at least about 65%, or at least about 70%, or at least about 75%. Generally, the greater the amount of pore forming agent in the ceramic precursor composition, the higher the porosity of the ceramic material or structure obtained therefrom, e.g., by firing or sintering. In certain embodiments, the pore forming agent is present in an amount suitable to obtain a ceramic material or structure having a porosity of from about 50% to about 75%, or from about 55% to about 70%, or from about 55% to about 65%, or from about 60% to about 70%, or from about 60% to about 65%.

In certain embodiments, the ceramic precursor composition comprises from about 10 wt. % to about 90 wt. % of pore forming agent, relative to the total combined weight of the first, second and third inorganic particulate materials. Thus, for example, if the ceramic precursor consisted entirely of the first, second and third inorganic particulate materials, and 50 wt. % pore forming agent relative to the total combined weight of the first, second and third inorganic particulate materials, the weight ratio of the total combined weight of the first, second and third inorganic materials to the weight of pore forming agent would be 1:1. If the ceramic precursor composition has a tetramodal particle size distribution, then the amounts described herein would be relative to the total combined weight of the first, second, third and fourth inorganic particulate materials. Likewise, if the ceramic precursor composition has a pentamodal particle size distribution, then the amounts described herein would be relative to the total combined weight of the first, second, third and fourth inorganic particulate materials. This principle applies to any component which is described in terms of an amount relative to the total amount of said inorganic particulate materials.

In certain embodiments, the ceramic precursor composition comprises from about 20 wt. % to about 85 wt. % of pore forming agent, for example, from about 30 wt. % to about 80 wt. %, or from about 40 wt. % to about 80 wt. %, or from about 45 wt. % to about 80 wt. %, or from about 45 wt. % to about 75 wt. %, or from about 50 wt. % to about 80 wt. %, or from about 50 wt. % to about 75 wt. %, or from about 50 wt. % to about 70 wt. %, or form about 50 wt. % to about 65 wt. %, or from about 55 wt. % to about 70 wt. %, or from about 60 wt. % to about 70 wt. %, relative to the total combined weight of the first, second and third inorganic particulate materials.

Suitable pore forming agents include graphite or other forms of carbon, cellulose and cellulose derivatives, starch, organic polymers, plastics and mixtures thereof. In certain embodiments, the pore forming agent comprises or is starch. In certain embodiments, the pore forming agent comprises or is a plastic, for example, a polymer microsphere, for example, a copolymer of acrylates such as, for example, a copolymer of methyl methacrylate, for example, a copolymer of methyl methacrylate and an alkyleneglycol dimethacrylate (e.g., a copolymer of methyl methacrylate and ethyleneglycol dimethacrylate).

In certain embodiments, the pore forming agent has a d₅₀ of from about 20 to about 50 μm, for example, from about 20 to about 45 μm, or from about 20 to about 40 μm, or from about 20 to about 35 μm. In such embodiments, the pore forming agent may have a density of from about 1.0 to 2.5 g/cm³.

The ceramic precursor composition may further comprise binding agent(s), auxiliant(s) and/or solvent. Binding agents and auxiliants that may be used in the present invention are all commercially available from various sources known to the skilled person in the art.

The function of the binding agent is to provide a sufficient mechanical stability of the green structure in the process steps before the heating or sintering. The additional auxiliants provide the raw material, i.e., ceramic precursor composition, with advantageous properties of the extrusion step (e.g., plasticizers, glidants, lubricants, and the like).

In embodiments, the ceramic precursor composition (or the extrudable mixture or green structure formed therefrom) comprises one or more binding agents selected from the group consisting of, methyl cellulose, hydroxymethylpropyl cellulose, polyvinyl butyrals, emulsified acrylates, polyvinyl alcohols, polyvinyl pyrrolidones, polyacrylics, starch, silicon binders, polyacrylates, silicates, polyethylene imine, lignosulfonates, and alginates.

The binding agents can be present in a total amount from about 0.5 wt. % to about 20 wt. %, for example, from about 0.5 wt. % to about 15%, or from about 2 wt. % to about 10 wt. %, or up to about 5 wt. %, relative to the total combined weight of the first, second and third inorganic particulate materials.

In a further embodiment, the ceramic precursor composition (or the extrudable mixture or green structure formed therefrom) comprises one or more auxiliants (e.g. plasticizers and lubricants) selected from the groups consisting of polyethylene glycols (PEGs), glycerol, ethylene glycol, octyl phthalates, ammonium stearates, wax emulsions, oleic acid, Manhattan fish oil, stearic acid, wax, palmitic acid, linoleic acid, myristic acid, and lauric acid.

The auxiliants can be present in a total amount of from about 0.5 wt. % to about 40 wt. %, for example, from about 0.5 wt. % to about 35 wt. %, or from about 5 wt. % to about 30 wt. %, or from about 10 wt. % and about 30 wt. %, or from about 20 wt. % to about 30 wt. %, relative to the total between 2% and 9%, relative to the total combined weight of the first, second and third inorganic particulate materials.

The ceramic precursor composition may be combined with solvent. The solvent may be an organic or aqueous liquid medium. In certain embodiments, the solvent is water. The solvent, e.g., water, may be present in an amount ranging from about 1 wt. % to about 100 wt. %, relative to the total combined weight of the first, second and third inorganic particulate materials, for example, from about 5 wt. % to about 90 wt. %, or from about 25 wt. % to about 75 wt. %, or from about 35 wt. % to about 65 wt. %, or from about 40 wt. % to about 60 wt. %, or from about 45 wt. % to 55 wt. %, relative to the total combined weight of the first, second and third inorganic particulate materials.

In a further embodiment, the ceramic precursor composition (or the extrudable mixture or green honeycomb structure formed therefrom) comprises one or more mineral binders. Suitable mineral binder may be selected from the group including, but not limited to, one or more of bentonite, aluminum phosphate, boehmite, sodium silicates, boron silicates, or mixtures thereof. The mineral binders can be present in a total amount of up to about 10 wt. %, for example, from about 0.1 wt. % to about 10 wt. %, or from about 0.5 wt. % to about 5.0 wt. %, or from about 1.0 wt. % to about 3.0 wt. %, relative to the total combined weight of the first, second and third inorganic particulate materials.

In certain embodiments, the third inorganic particulate acts, at least in part, as a binder in the ceramic precursor composition. Without wishing to be bound by theory, it is believed that the relatively small particle size of the third inorganic particulate material enables the particulate, for example, the titania and alumina precursor materials, to take part in a bindering or sticking process during firing/sintering of the ceramic precursor composition. This may enhance the stability of the ceramic structure at higher temperatures compared to ceramic structures prepared without the relatively fine third inorganic particulate material described herein.

The ceramic precursor composition may comprise minerals other than the first, second and third inorganic particulate materials and any other mineral based additives described herein. In certain embodiments, the ceramic precursor composition does not comprise mineral additives other than the first, second and third inorganic particulate materials described herein. In certain embodiments in which the ceramic precursor composition has a tetramodal particle size distribution and comprises first, second, third and fourth inorganic particulate materials, the ceramic precursor composition does not comprise mineral additives other than the first, second, third and fourth inorganic particulate materials described herein.

### Ceramic Structures

The ceramic materials and structures of the present invention have a tialite content of at least about 50 wt. %, based on the total weight of the ceramic material, and a porosity of at least about 50% (calculated on the basis of the total volume of the mineral phases and pore space of the ceramic material). The ceramic material or structure is obtained by or prepared by a method comprising:
(i) providing, preparing or obtaining a ceramic precursor composition having at least a trimodal particle size and having a composition comprising:
   (a) a first inorganic particulate material having a coarse particle size distribution;
   (b) a second inorganic particulate material having a particle size distribution which is finer than (a);
   (c) a third inorganic particulate material having a d₅₀ of equal to or less than about 5 μm and optionally having a particle size distribution which is finer than (b); and
   (d) a or at least one pore forming agent in an amount suitable to obtain a ceramic material having a porosity of at least about 50%;
(ii) forming a green ceramic material from the ceramic precursor composition, and
(iii) sintering the green ceramic material.

In certain embodiments, the ceramic precursor composition has a composition as described above. That is, the ceramic precursor composition may have a composition according to each and every embodiment of the first aspect of the present invention.

The preparation of the ceramic precursor composition (optionally in combination with binding agent(s), mineral binder(s) and/or auxiliant(s)) is performed according to methods and techniques known in the art. (e.g., as described in Extrusion in Ceramics, F. Handle, 2007, Springer). For, example, the components of the ceramic precursor composition can be mixed in a conventional kneading machine with the addition of a suitable amount of a suitable liquid phase as needed (normally water) to a slurry or paste suitable for further processing, e.g., by extrusion. In certain embodiments, the ceramic precursor composition is prepared as an extrudable mixture.

Additionally, conventional extruding equipment (such as, e.g., a screw extruder) and dies, e.g., for the extrusion of honeycomb structures, known in the art can be used. A summary of the technology is given in the textbook of W. Kollenberg (ed.), Technische Keramik, Vulkan-Verlag, Essen, Germany, 2004, which is incorporated herein by reference.

For extruded pieces, the size and shape of green structures (e.g., green honeycomb structures, based on the diameter of such) can be determined by selecting extruder dies of desired size and shape. After extrusion, the extruded mass may be cut into pieces, for example, monolith pieces, of suitable length, for example, to obtain green honeycomb structures of desired format. Suitable cutting means for this step (such as wire cutters) are known to the person skilled in the art.

The (optionally extruded) green structure formed from the ceramic precursor composition, for example, green honeycomb structure, can be dried according to methods known in the art (e.g., microwave drying, hot-air drying) prior to sintering.

The dried green structure is then heated for preparation of ceramic materials and structures therefrom. Generally, any oven or kiln that is suitable to subject the heated objects to a predefined temperature and/or controlled heating and cooling cycle is suitable for the process of the invention. Steps may be taken to control the temperature during heating and cooling. Steps may also be taken to control the gaseous environment in the over or kiln, for example, to control the oxygen content. In certain embodiments, heating is conducted under an atmosphere of reduce oxygen content (i.e., less than the oxygen content of air, which is about 21%). This may enhance the homogenous burn out of the pore forming agent during heating (e.g., at temperatures between about 180° C. and 600° C.) and, in turn, enhance the thermal parameters of the ceramic material or structure having the advantageously high porosity. In certain embodiments, the oxygen content of the atmosphere in the oven or kiln is less than about 10% by volume, for example, less than about 5% by volume, or less than about 2% by volume. An atmosphere having reduced oxygen may be obtained, for example, by introducing a suitable amount of an inert gas, e.g., nitrogen and/or argon, or by introducing a re-circulated exhaust gas (e.g., a mixture of air and exhaust gas from the oven or kiln).

In certain embodiments, the green honeycomb structure maybe plugged prior to sintering. In other embodiments, the plugging may be carried out after sintering. Further details of the plugging process are described below.

When the green structure comprises organic binder compound and/or organic auxiliants, usually the structure is heated to a temperature in the range of from about 150° C. to about 400° C., for example, from 200° C. to about 400° C., or from about 200° C. to about 300° C., prior to heating the structure to the final sintering temperature, and that temperature is maintained for a period of time that is sufficient to remove the organic binder and auxiliant compounds by means of combustion (for example, between one and three hours).

The pre-sintered ceramic structure may be sintered at a temperature of higher than about 1400° C., for example, a temperature up to about 1700° C., or between about 1450° C. and 1650° C., or between about 1450° C. and 1600° C., or between about 1450° C. and 1550° C., or between about 1475° C. and 1525° C., or at a temperature of about 1500° C.

In certain embodiments, the method comprises steps of:
(i)(1) providing, preparing or obtaining an extrudable mixture formed from the ceramic precursor composition;
(i)(2) extruding the mixture to form a green ceramic structure, for example, a green honeycomb structure;
(i)(3) drying the green ceramic structure; and
(ii) sintering the green ceramic structure, for example, at a temperature higher than 1400° C.

Sintering may be performed for a suitable period of time and a suitable temperature such that ceramic material or structure comprises at least about 50% by weight tialite and has a porosity of at least about 50% (calculated on the basis of the total volume of the mineral phases and pore space of the ceramic material).

In certain embodiments, the ceramic material or structure has a porosity of at least about 55%, for example, equal to or greater than about 60%, or equal to or greater than about 61%, or equal to or greater than about 62%, or equal to or greater than about 63%, or equal to or greater than about 64%, or equal to or greater than about 65%. In certain embodiments, the ceramic material or structure has a porosity of at from about 50% to about 75%, for example, from about 55% to about 70%, or from about 60% to about 70%, or from about 60% to about 65%. In such embodiments, the ceramic material or structure may have a tialite content of at least about 55 wt. %, or at least about 60 wt. %, or at least about 65 wt. %%, or at least about 70 wt. %, or at least about 75 wt. %, or at least about 80 wt. %. In certain embodiments, the ceramic material or structure has a tialite content of from about 60 wt. % to about 100 wt. %, for example, from about 60 wt. % to about 90 wt. %, or from about 65 wt. % to about 85 wt. %, or from about 70 wt. % to about 80 wt. %, or from about 70 wt. % to about 75 wt. %.

In certain embodiments, the ceramic material or structure has a porosity of at least about 60% and a tialite content of equal to or greater than 60 wt. %, for example, equal to or greater than about 65 wt. %, or from about 65 wt. % to about 85 wt. %, or from about 70 wt. % to about 80 wt. %, or from about 70 wt. % to about 75 wt. %.

In certain embodiments, the ceramic material or structure comprises from about 0 wt. % to about 40 wt. % mullite, for example, from about 10 wt. % to about 40 wt. % mullite, or from about 20 wt. % to about 35 wt. % mullite, or from about 20 wt. % to about 30 wt. % mullite, of from about 25-30 wt. % mullite.

In certain embodiments, mullite and tialite mineral phases constitute at least about 80% of the total weight of the mineral phases of the ceramic material or structure, for example, at least about 85% of the total weight of the mineral phases, or at least about 90% of the total weight of the mineral phases, or at least about 92% of the total weight of the mineral phases, or at least about 94%, or at least about 96%, or at least about 97%, or at least about 98%, or at least about 99% of the total weight of the mineral phases, or up to about 98.5 wt. % of the mineral phases, or up to about 98.0 wt. % of the mineral phases, or up to about 97.5% of the mineral phases, or up to about 97.0% of the mineral phases, or up to about 96.5% of the mineral phases, or up to about 96.0% of the mineral phases, or up to about 95.5% of the mineral phases, or up to about 95.0% of the mineral phases.

In certain embodiments, the ceramic material or structure comprises up to about 5.0 wt. % Zr-containing mineral phase, for example, from about 0.1 wt. % to about 5.0 wt. % Zr-containing mineral phase, or from about 0.1 wt. % to about 3.5 wt. % Zr-containing mineral phase, or from about 0.5 wt. % to about 2.0 wt. % Zr-containing mineral phase. In certain embodiments, the Zr-containing mineral phase comprises ZrO (i.e., zirconia). In certain embodiments, the Zr-containing mineral phase comprises zirconium titanate. In certain embodiments, the Zr-containing mineral phase comprises ZrO and zirconium titanate. In certain embodiments, zirconium titanate has the chemical formula Tiₓ Zr₁₋ₓO₂, wherein x is from 0.1 to about 0.9, for example, greater than about 0.5. In embodiments, the Zr-containing mineral phase comprise a mixture of ZrO₂ and Tiₓ Zr₁₋ₓO₂. In certain embodiments, the ceramic material or structure is substantially free of an Zr-containing mineral phase, e.g., free of ZrO₂.

Additionally or alternatively, the ceramic material or structure may further comprise from about 0-3.0 wt. % of alkaline earth metal-containing mineral phase, for example, from about 0.5-2.5 wt. %, or about 1.0-2.5 wt. %, or about 1.0-2.0 wt. %, or about 1.0-1.5 wt. % of alkaline earth metal-containing mineral phase. Advantageously, the alkaline earth metal-containing mineral phase is a Mg-containing mineral phase, for example, MgO.

In certain embodiments, the ceramic material or structure comprises one or more of alumina mineral phases and/or titania mineral phases and/or an amorphous phase. Alumina may be present in amount up to about 10 wt. %, for example, from about 2-8 wt. %, or from about 4.6 wt. %. Titania may be present in an amount up to about 5 wt. %, for example, up to about 3 wt. %, or up to about 2 wt. %, or up to about 1 wt.

The amorphous phase may comprise, consist essentially of, or consist of a glassy silica phase which may form at sintering temperatures between about 1400° C. and 1600° C. The amorphous phase may be present in an amount up to about 5 wt. %, for example, up to about 3 wt. %, or up to about 2 wt. %, or up to about 1 wt.

In certain embodiments, the ceramic composition is substantially free of alumina mineral phases and/or titania mineral phases and/or an amorphous phase.

In an embodiment, the amount of iron in the ceramic composition or ceramic honeycomb structure, measured as Fe₂O₃, is less than 5% by weight, and for example may be less than about 2 wt. %, or for example less than about 1 wt. %, or for example less than about 0.75 wt. %, or for example less than about 0.50 wt. %, or for example less than about 0.25 wt. %. The structure may be essentially free from iron, as may be achieved for example by using starting materials which are essentially free of iron. Iron content, measured as Fe₂O₃, may be measured by XRF.

In an embodiment, the amount of strontium, measured as SrO, is less than about 2 wt. %, and for example less than about 1 wt. %, or for example less than about 0.75 wt. %, or for example less than about 0.50 wt. %, or for example less than about 0.25 wt. %. The structure may be essentially free from strontium, as may be achieved for example by using starting materials which are essentially free of strontium. Strontium content, measured as SrO₂, may be measured by XRF.

In an embodiment, the amount of chromium, measured as Cr₂O₃, is less than about 2 wt. %, and for example less than about 1 wt. %, or for example less than about 0.75 wt. %, or for example less than about 0.50 wt. %, or for example less than about 0.25 wt. %. The structure may be essentially free from chromium, as may be achieved for example by using starting materials which are essentially free of chromium. Chromium content, measured as Cr₂O₃, may be measured by XRF.

In an embodiment, the amount of tungsten, measured as W₂O₃, is less than about 2 wt. %, and for example less than about 1 wt. %, or for example less than about 0.75 wt. %, or for example less than about 0.50 wt. %, or for example less than about 0.25 wt. %. The structure may be essentially free from tungsten, as may be achieved for example by using starting materials which are essentially free of tungsten. Tungsten content, measured as W₂O₃, may be measured by XRF.

In an embodiment, the amount of yttria, measured as Y₂O₃, is less than about 2.5 wt. %, for example, less than about 2.0 wt. %, for example, less than about 1.5 wt. %, for example, less than about 1 wt. %, for example, less than about 0.5 wt. %, for example, in the range of about 0.3-0.4 wt. %. Any yttria present may be derived from yttria-stabilized zirconia which in embodiments may be used as a source of zirconia. The structure may be essentially free from yttria, as may be achieved for example by using starting materials which are essentially free of yttria. Yttria content, measured as Y₂O₃, may be measured by XRF.

In an embodiment, the amount of rare earth metals, measured as Ln₂O₃ (wherein Ln represents any one or more of the lanthanide elements La, Ce, Pr, Nd, Pm, Sm, Eu, Gd, Tb, Dy, Ho, Er, Tm, Yb and Lu), is less than about 2 wt. %, and for example less than about 1 wt. %, or for example less than about 0.75 wt. %, or for example less than about 0.50 wt. %, or for example less than about 0.25 wt. %. The structure may be essentially free from rare earth metals, as may be achieved for example by using starting materials which are essentially free of rare earth metals. Rare earth content, measured as Ln₂O₃, may be measured by XRF.

In certain embodiments, the ceramic composition has a pore size (d₅₀) of from about 5.0 μm to 25.0 μm, for example, from about 5.0 μm to 20.0 μm, for example, from about 7.5 μm to 20.0 μm, or from about 10.0 μm to 20.0 μm, or from about 10.0 μm to about 15.0 μm, or from about 12.0 μm to about 15.0 μm. Pore size may be determined by mercury porosimetry using a Pascal 140 series mercury porosimeter from Thermo Scientific (Thermo Fisher). The software employed is S.O.L.I.D. S/W, version 1.3.3 from Thermo Scientific. A sample weight of 1.0 g+/−0.5 g is typically used for this measurement.

In certain embodiments, the ceramic material or structure has a porosity of at least about 55%, for example, at least about 60%, a tialite content of equal to or greater than 60 wt. %, for example, equal to or greater than about 65 wt. %, or from about 65 wt. % to about 85 wt. %, or from about 70 wt. % to about 80 wt. %, or from about 70 wt. % to about 75 wt. %, and a pore size of from about 10.0 to about 30.0 μm, for example, from about 10.0 to about 25.0 μm, or from about 10.0 to about 20.0 μm, or from about 10.0 to about 15 μm, or from about 12.0 to about 15.0 μm.

In certain embodiments, the ceramic composition, e.g., ceramic honeycomb structure, exhibits favourable high temperature mechanical and thermal mechanical properties.

In certain embodiments, the ceramic material or structure, ceramic honeycomb structure, of any of the above embodiments, has a coefficient of thermal expansion (CTE) of equal to or less than about 4.0×10⁻⁶° C.⁻¹, as measured at 800° C. by dilatometry according to DIN 51045 using a Dilatometer Netzsch—model DIL 402 C, and a sample length of 25 mm+/−2 mm. In certain embodiments, the CTE may be equal to or less than about 3.0×10⁻⁶° C.⁻¹, for example, equal to or less than about 2.5×10⁻⁶° C.⁻¹, or equal to or less than about 2.0×10⁻⁶° C.⁻¹, or equal to or less than about 1.75×10⁻⁶° C.⁻¹, or equal to or less than about 1.5×10⁻⁶° C.⁻¹. In certain embodiments, the CTE is at least about 0.75 10⁻⁶° C.⁻¹, for example at least about 1.0 10⁻⁶° C.⁻¹, or at least about 1.25 10⁻⁶° C.⁻¹.

The thermal strength parameter (TSP) of the ceramic material or structure, e.g., ceramic honeycomb structure, is determined in accordance with the following equation:

TSP=[MOR/(CTE×Young's Modulus)] (1)

MOR is the modulus of rupture (MOR), also referred to as mechanical resistance, of the ceramic material or structure, e.g., ceramic honeycomb structure, and measured by flexural strength measurement with a 3 point bending test at ambient temperature. In the test method a test specimen rests on two supports and is loaded by means of a loading roller with one support. The press equipment was Mecmesin Multitest 2.5-d (AFG 2500N), Mecmesin LTC.

The Young's modulus is determined in accordance with DIN EN 843-2:2007 using Pundit Lab+ultra sound equipment available from Proceq. The test sample is a honeycomb sample cut with dimensions of 55 mm×55 mm+/−10 mm, length 50 mm+/−5 mm. The measurement is made in the longitudinal channels direction (with 250 KHz transducers with diameter 33 mm) with a resolution of greater than 0.1 μs.

In certain embodiments, the ceramic material or structure, e.g., ceramic honeycomb structure, of any of the above embodiments, has a mechanical resistance (MOR) of at least about 0.5 MPa, for example, at least about 0.6 MPa, or at least about 0.7 MPa, or at least about 0.8 MPa, or higher than 0.8 MPa. In certain embodiments, the MOR is from about 0.5 MPa to about 2.5 MPa, for example, from about 1.0 MPa to about 1.0 MPa, or from about 1.5 MPa to about 2.0 MPa. In such embodiments, the ceramic material or structure, e.g., ceramic honeycomb structure, may have a porosity of In certain embodiments, the ceramic material or structure has a porosity of at least about 55%, for example, equal to or greater than about 60%, or equal to or greater than about 61%, or equal to or greater than about 62%, or equal to or greater than about 63%, or equal to or greater than about 64%, or equal to or greater than about 65%.

In certain embodiments, the ceramic material or structure has a porosity of at from about 50% to about 75%, for example, from about 55% to about 70%, or from about 60% to about 70%, or from about 60% to about 65%.

In certain embodiments, the ceramic material or structure, e.g., ceramic honeycomb structure, of any of the above embodiments, has a Young's modulus of no greater than about 10 GPa, for example, no greater than about 8.0 GPa, or no greater than about 6.0 GPa. In certain embodiments, the Young's modulus is from about 3.0 to about 7.0 GPa, for example, from about 4.0 to about 6.0 GPa.

The thermal strength parameter (TSP) of the ceramic material or structure, e.g., ceramic honeycomb structure, is determined in accordance with the following equation:

TSP=[MOR/(CTE×Young's Modulus)] (1)

In certain embodiments, the ceramic material or structure, e.g., ceramic honeycomb structure, of any of the above embodiments, has a TSP of at least about 60° C., for example, at least about 80° C., or at least about 100° C., or at least about 125° C., or at least about 150° C., or at least about 200° C., or at least about 250° C., or at least about 300° C., or at least about 350° C. In certain embodiments, the TSP is no greater than about 550° C., for example, no greater than about 500° C., for example, no greater than about 450° C., or no greater than about 400° C. In such embodiments, the ceramic material or structure, e.g., ceramic honeycomb structure, may have a porosity of In certain embodiments, the ceramic material or structure has a porosity of at least about 55%, for example, equal to or greater than about 60%, or equal to or greater than about 61%, or equal to or greater than about 62%, or equal to or greater than about 63%, or equal to or greater than about 64%, or equal to or greater than about 65%. In certain embodiments, the ceramic material or structure has a porosity of at from about 50% to about 75%, for example, from about 55% to about 70%, or from about 60% to about 70%, or from about 60% to about 65%.

In certain embodiments, the ceramic material or structure, e.g., ceramic honeycomb structure, of any of the above embodiments, has an absolute (skeleton) of from about 3.0 to about 4.0 g/cm³, for example, from about 3.3 to about 3.7 g/cm³. Skeleton density may be measured with a Picnometer (Accupic—Micrometrics). Additionally or alternatively, the ceramic material or structure, e.g., ceramic honeycomb structure, of any of the above embodiments, has a bulk density of from about 1.0 to about 1.5 g/cm³, for example, from about 1.1 to about 1.4 g/cm³, or from about 1.2 to about 1.3 g/cm³. In such embodiments, the ceramic material or structure, e.g., ceramic honeycomb structure, may have a porosity of In certain embodiments, the ceramic material or structure has a porosity of at least about 55%, for example, equal to or greater than about 60%, or equal to or greater than about 61%, or equal to or greater than about 62%, or equal to or greater than about 63%, or equal to or greater than about 64%, or equal to or greater than about 65%. In certain embodiments, the ceramic material or structure has a porosity of at from about 50% to about 75%, for example, from about 55% to about 70%, or from about 60% to about 70%, or from about 60% to about 65%.

In certain embodiments, the ceramic material or structure, e.g., ceramic honeycomb structure has: (i) a MOR of from about 1.0 MPa to about 2.5 MPa, for example, from about 1.0 MPa to about 2.0 MPa; and/or (ii) a Young's Modulus of less than about 10 GPa, for example, from about 3.5 GPa to about 6.0 GPa; and/or (iii) a TSP of at least about 100° C., for example, from about 120° C. to about 400° C.; and/or (iv) a CTE of from about 0.5×10⁻⁶° C.⁻¹ to about 3.5×10⁻⁶° C.⁻¹; and/or (v) a porosity of from about 55% to about 70%, for example, from about 60% to about 70%; and optionally (vi) an absolute (skeleton) density of from about 3.0 to 4.0 g/cm³, for example, from about 3.3 to about 3.7 g/cm³.

In certain embodiments, the ceramic material or structure, e.g., ceramic honeycomb structure has: (i) a MOR of from about 0.8 MPa to about 2.5 MPa, for example, from about 1.0 MPa to about 2.5 MPa, for example, from about 1.0 MPa to about 2.0 MPa; and (ii) a Young's Modulus of less than about 10 GPa, for example, from about 2.5 GPa to about 6.0 GPa, or from about 3.5 GPa to about 6.0 GPa; and (iii) a TSP of at least about 100° C., for example, from about 120° C. to about 400° C.; and (iv) a CTE of from about 0.5×10⁻⁶° C.⁻¹ to about 3.5×10⁻⁶° C.⁻¹; and (v) a porosity of from about 55% to about 70%, for example, from about 60% to about 70%; and optionally (vi) an absolute density of from about 3.0 to 4.0 g/cm³, for example, from about 3.3 to about 3.7 g/cm³.

### Ceramic Honeycomb Structures:

In the ceramic honeycomb structures described in the above embodiments, the optimal pore diameter is in the range between 5 to 30 μm, or 10 to 25 μm. Depending on the intended use of the ceramic honeycombs, in particular with regard to the question whether the ceramic honeycomb structure is further impregnated, e.g., with a catalyst, the above values may be varied. For impregnated structures, the range is usually between 10 and 25 μm prior to impregnating, for example, between 15 and 25 μm, or between about 15 and 20 μm prior to impregnating. The catalyst material deposited in the pore space will result in a reduction of the original pore diameter.

The honeycomb structure of the invention can typically include a plurality of cells side by side in a longitudinal direction that are separated by porous partitions and plugged in an alternating (e.g., checkerboard) fashion. In one embodiment, the cells of the honeycomb structure are arranged in a repeating pattern. The cells can be square, round, rectangular, octagonal, polygonal or any other shape or combination of shapes that are suitable for arrangement in a repeating pattern. Optionally, the opening area at one end face of the honeycomb structural body can be different from an opening area at the other end face thereof. For example, the honeycomb structural body can have a group of large volume through-holes plugged so as to make a relatively large sum of opening areas on its gas inlet side and a group of small volume through-holes plugged so as to make a relatively small sum of opening areas on its gas outlet side.

In certain embodiments, the cells of the honeycomb structure are arranged asymmetrically. For example, in accordance with the structures described in WO-A-2011/117385, the entire contents of which are hereby incorporated by reference.

An average cell density of the honeycomb structure of the present invention is not limited. The ceramic honeycomb structure may have a cell density between 6 and 2000 cells/square inch (0.9 to 311 cells/cm²), or between 50 and 1000 cells/square inch (7.8 to 155 cells/cm²), or between 100 and 400 cells/square inch (15.5 to 62.0 cells/cm²).

The thickness of the partition wall separating adjacent cells in the present invention is not limited. The thickness of the partition wall may range from 100 to 500 microns, or from 200 to 450 microns.

Moreover, the outer peripheral wall of the structure is preferably thicker than the partition walls, and its thickness may be in a range of 100 to 700 microns, or 200 to 400 microns. The outer peripheral wall may be not only a wall formed integrally with the partition wall at the time of the forming but also a cement coated wall formed by grinding an outer periphery into a predetermined shape.

In certain embodiments, the ceramic honeycomb structure is of a modular form in which a series of ceramic honeycomb structures are prepared in accordance with the present invention and then combined to form a composite ceramic honeycomb structure. The series of honeycomb structures may be combined whilst in the green state, prior to sintering or, alternatively, may be individually sintered, and then combined. In certain embodiments, the composite ceramic honeycomb structure may comprise a series of ceramic honeycomb structures prepared in accordance with present invention and ceramic honeycomb structures not in accordance with the present invention.

For the use as a diesel particulate filter (DPF), selective diesel particulate filter (S-DPF), also known as selective catalyst reduction filter (SCRF), or gasoline particulate filer (GPF), the ceramic honeycomb structures of the present invention, or the green ceramic honeycomb structures of the present invention can be further processed by plugging, i.e., close certain open structures of the honeycomb at predefined positions with additional ceramic mass. Plugging processes thus include the preparation of a suitable plugging mass, applying the plugging mass to the desired positions of the ceramic or green honeycomb structure, and subjecting the plugged honeycomb structure to an additional sintering step, or sintering the plugged green honeycomb structure in one step, wherein the plugging mass is transformed into a ceramic plugging mass having suitable properties for use in a diesel particulate filter, selective diesel particulate filter or gasoline particulate filer. It is not required that the ceramic plugging mass is of the same composition as the ceramic mass of the honeycomb body. Generally, methods and materials for plugging known to the person skilled in the art may be applied for the plugging of the honeycombs of the present invention. In an exemplary process about 50% of the inlet channels are plugged on one side of the honeycomb piece and on the opposite side a further 50% of the channels are plugged in order such that, in use, exhaust gas is forced to pass through walls of the honeycomb structure.

The plugged ceramic honeycomb structure may then be fixed in a box suitable for mounting the structure into the exhaust gas line of a diesel or gasoline engine, for example, the diesel or gasoline engine of a vehicle (e.g., automobile, truck, van, motorbike, digger, excavator, tractor, bulldozer, dump-truck, and the like).

### SCR (Selective Catalyst Reduction) Catalyst System

In certain embodiments, the ceramic materials and structures described in the above embodiments may be comprised in a SCR catalyst system. Thus, the ceramic material or structure may be combined (e.g., coated) with an amount of a SCR catalyst. The ceramic structure may be in the form of a honeycomb structure, as described above. The SCR catalyst system may be part of a boiler system, for example, household, industrial or municipal solid waste boilers. The SCR catalyst system may be applied, e.g., mounted into the exhaust gas line of a diesel engine, for example, in ships, diesel locomotives, gas turbines and vehicles (e.g., e.g., automobile, truck, van, motorbike, digger, excavator, tractor, bulldozer, dump-truck, and the like).

In such systems the ceramic material or structure functions as filter (i.e., similar to or in the same way as its typical function in a diesel particulate filter). The SCR catalyst may be coated on an exhaust gas inlet of the filter. Other materials may be coated on the exhaust gas outlet of the filter, for example, an aluminium oxide layer, and a precious metal catalyst layer formed on the surface of the aluminium oxide layer, as described in US-A-2013136662, the entire contents of which are hereby incorporated by reference. Other SCR coatings, including those suitable for NOx emissions reduction for diesel engine exhaust after treatment, include vanadia (vanadium (V) oxide), Fe-zeolite and/or Cu-zeolite. These and other systems are described in publications such as ‘Urea-SCR Technology for deNOx after treatment of Diesel Exhaust’, I. Nova & E. Tronconi, Springer).

The present invention is further described in the following non-limiting examples.

### EXAMPLES

A series of ceramic pieces were obtained from the ceramic precursor compositions described in Tables 1-7. Compositional analysis and thermomechanical properties were determined in accordance with the methods described above.

Tables 1-6: Samples were extruded and fired at 1500° C. for 2 hours. Table 7: Samples were extruded and fired at 1525° C. for 2 hours. In each case, the oxygen content of the atmosphere in the kiln was 5% by volume.

AT coarse powder=alumina titanate powder having a d₅₀ of about 24 μm (chemical composition comprising 92% TiO_{2/}Al₂O₃, about 5% ZrO₂ and about 2% MgO

M coarse powder=mullite powder having a d₅₀ of about 32 μm (chemical composition comprising about 98% Al₂O₃/SiO₂)

M precursor coarse powder=mullite powder having a d₅₀ of about 60 μm (chemical composition comprising about 80% Al₂O₃/20% SiO₂)

AT intermediate powder=alumina titanate powder having a d₅₀ of about 4.3 μm (chemical composition as per AT coarse powder)

AT precursor intermediate powder=powder having a d₅₀ of about 17 μm (chemical composition comprising about 99% Al₂O₃/1% MgO)

M intermediate powder=mullite powder having a d₅₀ of about 7.2 μm (chemical composition comprising essentially 100% Al₂O₃/SiO₂)

AT precursor fine powder 1=alumina titanate precursor mixture having a d₅₀ of about 0.12 μm and a d₉₀ of about 0.65 μm (chemical composition comprising about 98% TiO_{2/}Al₂O₃)

AT precursor fine powder 2=alumina titanate precursor mixture having a d₅₀ of about 0.12 μm and a d₉₀ of about 1.2 μm (chemical composition comprising about 98% TiO_{2/}Al₂O₃ and about 1.9% MgO)

AT precursor fine powder 3=alumina titanate precursor mixture having a d₅₀ of about 0.9 μm (chemical composition comprising about 98% TiO_{2/}Al₂O₃ and about 1.9% MgO)

AT precursor fine powder 4=alumina titanate precursor mixture having a d₅₀ of about 3.8 μm (chemical composition comprising about 98% TiO_{2/}Al₂O₃ and about 1.9% MgO)

AT precursor fine powder 5=alumina titanate precursor mixture having a d₅₀ of about 2.1 μm (chemical composition comprising about 98% TiO_{2/}Al₂O₃ and about 1.9% MgO

AT precursor fine powder 6=powder having a d₅₀ of about 3 μm (chemical composition comprising about 95% Al₂O₃/5% ZrO₂)

TABLE 1

| Recipe (% weight) | C1 | C2 |
|---|---|---|
| AT coarse powder | 39% | 39% |
| M intermediate powder | 31% | 31% |
| AT precursor fine powder 2 | 30% | 30% |
| Total mineral solids | 100% | 100% |
| Starch | 64% | 0% |
| Polymer microspheres | 0% | 51% |
| Total porous agent | 64% | 51% |
| Plastifiers | 24% | 16% |
| Lubricants | 4% | 4% |
| Water | 46% | 28% |
| Total organics | 28% | 20% |
| Total | 238% | 199% |
| Pore size (microns) | 12 | 7 |
| Porosity (%) | 63 | 59 |

TABLE 2

| Recipe (% weight) | C3 | C1 | C4 |
|---|---|---|---|
| AT coarse powder | 39% | 39% | 39% |
| M intermediate powder | 31% | 31% | 31% |
| AT precursor fine powder 2 | 30% | 30% | 30% |
| Total mineral solids | 100% | 100% | 100% |
| Starch | 43% | 64% | 79% |
| Total porous agent | 43% | 64% | 79% |
| Plastifiers | 19% | 24% | 28% |
| Lubricants | 3% | 4% | 5% |
| Water | 56% | 46% | 86% |
| Total organics | 22% | 28% | 33% |
| Total | 220% | 238% | 299% |
| Pore size (microns) | 10 | 12 | 12 |
| Porosity (%) | 57 | 63 | 64 |

TABLE 3

| Recipe (% weight) | C5 | C2 | C6 | C7 |
|---|---|---|---|---|
| AT coarse powder | 39% | 39% | 3% | 3% |
| M coarse powder | 0% | 0% | 30% | 31% |
| M intermediate powder | 30% | 31% | 0% | 0% |
| AT intermediate powder | 0% | 0% | 37% | 37% |
| AT precursor fine powder 1 | 31% | 0% | 31% | 0% |
| AT precursor fine powder 2 | 0% | 30% | 0% | 30% |
| Total mineral solids | 100% | 100% | 100% | 100% |
| Polymer microspheres | 50% | 51% | 50% | 51% |
| Total porous agent | 50% | 51% | 50% | 51% |
| Plastifiers | 16% | 16% | 21% | 21% |
| Lubricants | 2% | 4% | 5% | 5% |
| Water | 36% | 28% | 32% | 32% |
| Total organics | 18% | 20% | 26% | 26% |
| Total | 204% | 199% | 208% | 209% |
| Pore size (microns) | 8 | 7 | 8 | 8 |
| Porosity (%) | 62 | 59 | 55 | 51 |

TABLE 4

| Recipe (% weight) | C1 | C8 | C9 | C10 | C11 |
|---|---|---|---|---|---|
| AT coarse powder | 39% | 44% | 49% | 45% | 50% |
| M intermediate powder | 31% | 26% | 22% | 31% | 31% |
| AT precursor fine powder 2 | 30% | 30% | 29% | 24% | 19% |
| Total mineral solids | 100% | 100% | 100% | 100% | 100% |
| Starch | 64% | 63% | 63% | 64% | 64% |
| Total porous agent | 64% | 63% | 63% | 64% | 64% |
| Plastifiers | 24% | 24% | 25% | 25% | 25% |
| Lubricants | 4% | 5% | 5% | 5% | 5% |
| Water | 46% | 48% | 49% | 50% | 51% |
| Total organics | 28% | 29% | 30% | 30% | 30% |
| Total | 238% | 240% | 242% | 244% | 245% |
| Pore size (microns) | 12 | 12 | 13 | 13 | 12 |
| Porosity (%) | 63 | 63 | 64 | 64 | 65 |

TABLE 5

| Recipe (% weight) | C1 | C12 | C13 | C14 |
|---|---|---|---|---|
| AT coarse powder | 39% | 39% | 39% | 39% |
| M intermediate powder | 31% | 31% | 31% | 31% |
| AT precursor fine powder 2 | 30% | 0% | 0% | 0% |
| AT precursor fine powder 3 | 0% | 30% | 0% | 0% |
| AT precursor fine powder 4 | 0% | 0% | 30% | 0% |
| AT precursor fine powder 5 | 0% | 0% | 0% | 30% |
| Total mineral solids | 100% | 100% | 100% | 100% |
| Starch | 64% | 64% | 64% | 64% |
| Total porous agent | 64% | 64% | 64% | 64% |
| Plastifiers | 24% | 24% | 25% | 24% |
| Lubricants | 4% | 4% | 5% | 4% |
| Water | 46% | 48% | 50% | 50% |
| Total organics | 28% | 28% | 30% | 28% |
| Total | 238% | 240% | 244% | 242% |
| Pore size (microns) | 12 | 12 | 12 | 12 |
| Porosity (%) | 63 | 63 | 62 | 62 |

TABLE 6

| Recipe (% weight) | C12 | C15 | C16 |
|---|---|---|---|
| AT coarse powder | 39% | 39% | 38% |
| M intermediate powder | 31% | 20% | 10% |
| AT intermediate powder | 0% | 12% | 24% |
| AT precursor fine powder 3 | 30% | 29% | 29% |
| Total mineral solids | 100% | 100% | 100% |
| Starch | 64% | 62% | 61% |
| Total porous agent | 64% | 62% | 61% |
| Plastifiers | 24% | 18% | 17% |
| Lubricants | 4% | 4% | 4% |
| Water | 48% | 42% | 41% |
| Total organics | 28% | 22% | 21% |
| Total | 240% | 226% | 223% |
| Pore size (microns) | 12 | 12 | 13 |
| Porosity (%) | 63 | 58 | 56 |
| CTE (0-800° C.) (*10⁻⁶° C.⁻¹) | 3 | 1.5 | 1 |
| MOR (MPa) | 2 | 1.7 | 1.5 |
| Elastic Modulus (Gpa) | 5 | 4.9 | 4 |
| TSP (° C.) | 130 | 230 | 370 |

TABLE 7

| Recipe (% weight) | C17 | C18 | C19 | C20 | C21 | C22 |
|---|---|---|---|---|---|---|
| M precursor coarse powder | 31% | 31% | 31% | 31% | 31% | 31% |
| AT precursor intermediate powder | 36% | 36% | 36% | 36% | 36% | 36% |
| AT precursor fine powder 6 | 33% | 33% | 33% | 33% | 33% | 33% |
| Total mineral solids | 100% | 100% | 100% | 100% | 100% | 100% |
| Starch | 58% | 44% | 49% | 54% | 39% | 35% |
| Graphite | 0% | 22% | 15% | 7% | 13% | 6% |
| Total porous agent | 58% | 66% | 63% | 61% | 52% | 41% |
| Plastifiers | 17% | 20% | 18% | 17% | 16% | 16% |
| Lubricants | 4% | 4% | 4% | 4% | 4% | 3% |
| Water | 40% | 47% | 42% | 41% | 39% | 36% |
| Total organics | 21% | 24% | 21% | 21% | 20% | 19% |
| Total | 220% | 236% | 227% | 223% | 211% | 196% |
| Pore size (microns) | 18 | 20 | 19 | 19 | 17 | 17 |
| Porosity (%) | 62 | 55 | 59 | 63 | 64 | 61 |
| CTE (0-800° C.) (*10⁻⁶° C.⁻¹) | 2.0 | 0.8 | 1.3 | 2.0 | 2.0 | 1.7 |
| MoR (MPa) | 0.8 | 1.2 | 1.1 | 0.9 | 1.0 | 1.1 |
| Elastic Modulus (GPa) | 2.7 | 3.0 | 3.0 | 2.7 | 2.8 | 3.0 |
| TSP (° C.) | 148 | 500 | 282 | 167 | 179 | 216 |

1. A ceramic precursor composition having at least a trimodal particle size distribution, the ceramic precursor composition comprising:
(a) a first inorganic particulate material having a coarse particle size distribution;
(b) a second inorganic particulate material having a particle size distribution which is finer than (a);
(c) a third inorganic particulate material having a d₅₀ of equal to or less than about 5 μm and optionally having a particle size distribution which is finer than (b); and
(d) at least one pore forming agent.

2. A ceramic composition according to claim 1, wherein the pore forming agent is present in an amount suitable to obtain a ceramic material having a porosity of at least about 50% (calculated on the basis of the total volume of the mineral phases and pore space of the ceramic material).

3. A ceramic precursor composition according to claim 1, wherein:
the first inorganic particulate material has a d₅₀ of from about 20 μm to about 80 μm;
the second inorganic particulate material has a d₅₀ of from about 1.0 μm to about 20 μm; and
the third inorganic particulate material has a particle size distribution finer than the second inorganic particulate material.

4. A ceramic precursor composition according claim 1, wherein:
the first inorganic particulate material is selected from tialite, one or more tialite-forming precursor compounds or compositions, and mullite and one or more mullite forming precursor compounds or compositions;
the second inorganic particulate material is selected from tialite, one or more tialite-forming precursor compounds or compositions, and mullite and one or more mullite forming precursor compounds or compositions; and
the third inorganic particulate is a tialite-forming precursor compound or composition.

5. A ceramic precursor composition according to claim 1, wherein the third inorganic particulate is a composition comprising:
from about 40 wt. % to about 60 wt. % titania,
from about 40 wt. % to about 60 wt. % alumina,
from about 0 wt. % up to about 5 wt. % of an alkaline earth metal-containing mineral phase and/or one or more alkaline earth metal-containing mineral phase-forming compounds or compositions, and
from about 0 wt. % to about 5 wt. % of a Zr-containing mineral phase and/or one or more Zr-containing mineral phase-forming compounds or compositions,
based on the total weight of the third inorganic particulate material.

6. A ceramic precursor composition according to claim 1, wherein the ceramic precursor composition comprises
from about 20 wt. % to about 60 wt. % of the first inorganic particulate material,
from about 15 wt. % to about 50 wt. % of the second inorganic particulate material, and
from about 15 wt. % to about 50 wt. % of the third inorganic particulate material,
based on the total combined weight of the first, second and third inorganic particulate materials.

7. A ceramic precursor composition according to claim 5, wherein the weight ratio of the first inorganic particulate material to the third inorganic particulate material is no greater than about 3:1.

8. A ceramic precursor composition according to claim 1, wherein the ceramic precursor composition comprises from about 10 wt. % to about 90 wt. % of pore-forming agent, relative to the total combined weight of the first, second and third inorganic particulate materials.

9. A ceramic precursor composition according to claim 1, wherein the pore forming agent has a d₅₀ of from about 20 μm to about 50 μm.

10. A ceramic precursor composition according to claim 1, further comprising:
(i) one or more binding agents;
(ii) one or more auxiliants; and/or
(iii) water and/or another solvent.

11. A method for making a ceramic material or structure having a tialite content of at least about 50% by weight and a porosity of at least about 50%, said method comprising:
(i) providing, preparing or obtaining a ceramic precursor having at least a trimodal particle size and having a composition comprising:
(a) a first inorganic particulate material having a coarse particle size distribution;
(b) a second inorganic particulate material having a particle size distribution which is finer than (a);
(c) a third inorganic particulate material having a d₅₀ of equal to or less than about 5 μm and optionally having a particle size distribution which is finer than (b); and
(d) a or at least one pore forming agent in an amount suitable to obtain a ceramic material having a porosity of at least about 50%;
(ii) forming a green ceramic material from the ceramic precursor composition, and
(iii) sintering the green ceramic material.

12. A method according to claim 11, wherein the ceramic precursor composition has a composition according to claim 3.

13. A method according to claim 11 wherein:
forming the green ceramic material comprises:
extruding the mixture to form a green ceramic structure,
the green ceramic structure is dried, and
sintering the green ceramic material comprises sintering at a temperature higher than 1400° C.

14. A method according to claim 13, wherein the green ceramic structure is in the form of a honeycomb and wherein the green ceramic structure is plugged.

15. A ceramic material or structure having a tialite content of at least about 50 wt. %, based on the total weight of the ceramic material or structure, and a porosity of at least about 50%, wherein the ceramic material or structure is obtained or prepared by a method comprising:
(i) providing, preparing or obtaining a ceramic precursor having at least a trimodal particle size and having a composition comprising:
(a) a first inorganic particulate material having a coarse particle size distribution;
(b) a second inorganic particulate material having a particle size distribution which is finer than (a);
(c) a third inorganic particulate material having a d₅₀ of equal to or less than about 5 μm and optionally having a particle size distribution which is finer than (b); and
(d) a or at least one pore forming agent in an amount suitable to obtain a ceramic material or structure having a porosity of at least about 50%;
(ii) forming a green ceramic material or structure from the ceramic precursor composition, and
(iii) sintering the green ceramic material or structure.

16. A ceramic material or structure according to claim 15, having a porosity of at least about 55%.

17. A ceramic material or structure according to claim 15 having a tialite content of equal to or greater than 65 wt. %.

18. A ceramic structure according to claim 15 in the form of a honeycomb structure.

19. A ceramic material or structure according to claim 15 having: (i) a MOR of from about 0.8 MPa to about 2.5 MPa, and/or (ii) a Young's Modulus of less than about 10 GPa, for example, from about 2.5 GPa to about 6.0 GPa; and/or (iii) a TSP of at least about 100° C.; and/or (iv) a CTE of from about 0.5×10⁻⁶° C.⁻¹ to about 3.5×10⁻⁶° C.⁻¹; and/or (v) a porosity of from about 55% to about 70% and/or (vi) an absolute (skeleton) density of from about 3.0 to 4.0 g/cm³.

20-22. (canceled)

23. A vehicle having a diesel engine and a filtration system comprising the diesel particulate filter or the selective diesel particulate filter according to claim 26.

24. A vehicle having a gasoline engine and a filtration system comprising the gasoline particulate filter according to claim 26.

25. A SCR catalyst system comprising a ceramic material or structure according to claim 15 and an SCR catalyst, optionally coated on a surface of the ceramic material or structure.

26. A diesel particulate filter, selective diesel particulate filter, or gasoline particulate filter comprising the ceramic honeycomb structure of claim 18.
